(19) United States
(12) Patent Application Publication
(10) Pub. No.: US 2018/0276287 A1
(43) Pub. Date: Sep. 27, 2018

(54) GENERATING CONTEXTUAL INSIGHTS FROM DEPLOYED APPLICATIONS IN MULTIPLE COMPUTING DEVICES

(71) Applicant: International Business Machines Corporation, Armonk, NY (US)

(72) Inventors: John Kurian, Bangalore (IN); Alwyn R. Lobo, Bangalore (IN); Ramkumar Ramalingam, Bangalore (IN); Venkatakrishnan Sampath Kumaran, Bangalore (IN)

(21) Appl. No.: 15/465,677

(22) Filed: Mar. 22, 2017

(51) Int. Cl. G06F 17/30

(52) U.S. Cl. CPC G06F 17/30572; G06F 3/0481; G06F 2203/04803

(57) ABSTRACT

A mashup system and method for providing contextual insights and notifications regarding a plurality of deployed applications deployed across a plurality of devices is provided. The method includes the steps of retrieving application data of the plurality of deployed applications generated by the plurality of devices, which is stored on a central cloud storage repository, identifying an application data associated with the first deployed application using a pre-defined data mining template corresponding to the first deployed application, and an application data associated with the second deployed application using a pre-defined data mining template corresponding to the second deployed application, and analyzing, the application data associated with the first deployed application and the application data associated with the second deployed application along with a user specific information to provide one or more contextual insights or notifications to the user on a single display associated with the computing system.

### TECHNICAL FIELD

The present invention relates to systems and methods of a mashing up multiple deployed applications deployed across multiple devices, and more specifically to embodiments of a mashup system and method that mashes up several deployed applications and provides contextual insights and notifications associated with the deployed applications deployed across multiple devices to a user device.

### BACKGROUND

Many people own multiple mobile devices, such as a mobile device for work and a mobile device for personal use. Similarly, multiple mobile devices can be distributed to a network, such as a family or organization. The same applications are often times installed on a majority of the mobile devices.

### SUMMARY

An embodiment of the present invention relates to a method, and associated computer system and computer program product, for providing contextual insights and notifications regarding a plurality of deployed applications deployed across a plurality of devices. A processor of a computing system retrieves application data of the plurality of deployed applications generated by the plurality of devices, which is stored on a central cloud storage repository, wherein the plurality of devices each include a first deployed application and a second deployed application. An application data associated with the first deployed application is identified using a pre-defined data mining template corresponding to the first deployed application, and an application data associated with the second deployed application is identified using a pre-defined data mining template corresponding to the second deployed application. The application data associated with the first deployed application and the application data associated with the second deployed application is analyzed along with a user specific information to provide one or more contextual insights or notifications to the user on a single display associated with the computing system.

### BRIEF DESCRIPTION OF THE DRAWINGS

FIG. 1 depicts a block diagram of a mashup system, in accordance with embodiments of the present invention.

FIG. 2 depicts a block diagram of mashup system and computing system, in accordance with embodiments of the present invention.

FIG. 3 depicts an embodiment of a dashboard of a user device displaying application data from several deployed application across several devices and various contextual insights, in accordance with embodiments of the present invention.

FIG. 4 depicts a flow chart of a first method for providing contextual insights and notifications regarding a plurality of deployed applications deployed across a plurality of devices, in accordance with embodiments of the present invention.

FIG. 5 depicts a flow chart of a second method for providing contextual insights and notifications regarding a plurality of deployed applications deployed across a plurality of devices, in accordance with embodiments of the present invention.

FIG. 6 illustrates a block diagram of a computer system for the mashup system of FIGS. 1-3, capable of implementing methods providing contextual insights and notifications regarding a plurality of deployed applications deployed across a plurality of devices of FIGS. 4-5, in accordance with embodiments of the present disclosure.

FIG. 7 depicts a cloud computing environment, in accordance with embodiments of the present invention.

FIG. 8 depicts abstraction model layers, in accordance with embodiments of the present invention.

### DETAILED DESCRIPTION

The increasing use of mobile devices and accompanying technology continue to change the way people live and do business. Mobile applications are being developed for more and more tasks, including e-mail, calendaring, to-do lists, social networking, personal finance, health monitoring, parental control, maps, travel, leisure etc. Most users have more than one mobile device, for example, one device may be for official work and the other mobile device may be used for personal use. Additionally, coworkers or dependent family members may also be using mobile devices that include the same applications installed on the other mobile devices, wherein the applications are running in silos.

In some embodiments, multiple devices may be running an application responsible for providing a set of functions or features to do a particular task or job. Because the applications are installed on the separate devices and the data is not communicated or shared with the other device, a user is not afforded a consolidated view of the user's tasks, reminders, appointments, schedule etc., in one place. For example, the applications installed on each mobile device typically run in a silo on each mobile device, such that application data is not shared between devices. In the current scenario, a user must open each application on each mobile device and understand/process the application data manually and co-ordinate the data found on one device and the data found on the other device. In an exemplary embodiment of the present invention, user details may be consolidated in one place and provide the user with some contextual insights based on user specific information, such as the user's past history, context and location. Cloud storage solutions, such as file hosting services, have gained immense popularity with mobile application developers and providers, as these solutions have helped applications users to pool together all of the users' data in one place with the ability to work with the users' data anytime, anywhere, and on any device. These cloud storage solutions make data available in a central repository in the cloud, but do not retrieve the data from the cloud and help the user by providing and/or generating one or more contextual insights or notifications, which may help the user do the user's work much more efficiently.

Furthermore, mobile applications can help to better manage everyday aspects of a user's daily activities. Applications can keep track of the user's daily schedule, personal notes, shopping, healthcare, finance, education, media, and retail. Employees are using mobile applications to access everything from customer relationship management (CRM) systems, to financial results, to marketing campaigns, to tracking orders, etc. With dedicated applications for managing every aspect of a user's life, one drawback is that the information related to the user's everyday life is being scattered across a plurality of different applications and across multiple devices.

In an exemplary embodiment in accordance with the present invention, a user may view all the related information using a mashup application installed on a user's mobile device, such that the user can view the related information “in a single pane of glass.” A “single pane of glass” may be a convenient method to view information typically spread across multiple applications and multiple devices, as opposed to being required to view all the related information from independent mobile applications from more than one device used or controlled by the user.

As an example, mobile applications like an expenses application and a to-do application may be used to describe an embodiment of the present invention. An expenses application can be dedicated to track personal finances, which allows managing day-to-day expenses and income. The expenses application may also allow setting of reminders for bill payments and reminders related to financial transactions. While the user is tracking the user's personal expenses with one device, at the same time, other expenses are tracked by the same application installed on another device (e.g. a mobile device used by the user's family member). However, the user just needs one single view on all the expenses made by the user and the user's family. A to-do list application can be dedicated to managing day-to-day tasks for a user, allowing the user to prioritize and schedule the user's work week. While the user uses one device to manage the user's personal tasks, the user currently uses another device for managing work related tasks, while another device manages his family member's task list. Given the above situation of applications installed in multiple devices, the user has no idea that the user's family is in need of some cash today as the other family members are running out of the cash because of the expenses. Also, while returning from the user's office, the user has no idea that the family is in need of some groceries for the day or some medicine that are running out of stock for his parents.

Because the user cannot access the application data stored on the other devices, the user has no clue about the expenses tracked by family members from another device and similarly the user has no clue about the to-do tasks maintained by family members for a need of groceries or medicines. The problem does not just end by these sample applications mentioned in this scenario; the problem grows exponentially when the user has to deal with dozens of applications installed in the user's mobile device(s). Accordingly, the user must open all the applications at least once in a day to identify priorities, wherein a frustration level raises exponentially when the number of applications installed in the mobile device grows over time.

Given this known limitation, that there is no proven techniques/solutions today to help these mobile application users to achieve a mashup of the users' data and build meaningful and contextual insights about the users' data. Embodiments of the present invention may provide a solution that helps mobile application users to build contextual insights via a dashboard with all the users' data stored in the cloud storage. For example, embodiments relate to a system and method to mashup the data stored/generated by all the deployed applications from multiple devices, and allow the user to build meaningful and contextual insights on the mobile device itself. In one embodiments, the application data is analyzed on the client side (e.g. by the user's mobile device), wherein no server side infrastructure or service is needed to analyze the device application data. However, other embodiments may utilize a server infrastructure to analyze the application data and service other requests from the user's mobile device. Furthermore, contextual insights may be generated from the application data without using expensive data analytics software. With the advancement in mobile device processing power, embodiments of the present invention include a method and a system to generate the contextual insights on the phone/device. Some advantages of this approach include a reduced or eliminated fear of data theft or misuse by cloud data analytics service provider, the user need not pay for the service, and predefined templates for contextual data insights can be utilized by the method and system, the predefined templates corresponding to popular applications, and customizable mashups and dashboard presentation of the data in anyway the user wants.

Moreover, the deployed application in multiple devices may utilize cloud storage to store the application data from multiple devices, which may be stored in an industry standard formation, such as JavaScript Objection Notation (JSON). For example, the data from all the deployed application in multiple devices may be stored in a central repository using a standardized data format (i.e., JSON) in a JSON Store. Usage of the same application across multiple devices occur, but with different user accounts. A mashup mobile application may be installed on the user's computing device, which may allow the user to build contextual insights for the data stored in central repository based on the user's requirements. Embodiments of the mashup application may be built with the following capabilities: a configurable option to choose a central repository (i.e., cloud storage) of interest, where the data from all the deployed applications in multiple devices are stored using a standardized JSON format; a pre-defined data mining templates for all the popular and commonly used applications, wherein the templates may identify the application data from same applications in multiple devices, and provide an insight into the application data, in a single view; a capability to store the personal details of the user, such as user-specific information including a work location, a home location, other location or GPS related details, and user history including preferences for shopping etc.; simple search API's that would help the user search the application data and customize the look and feel of the dashboard view; and interfaces to build and/or display insights from the application data in multiple applications to build a cross-application data view.

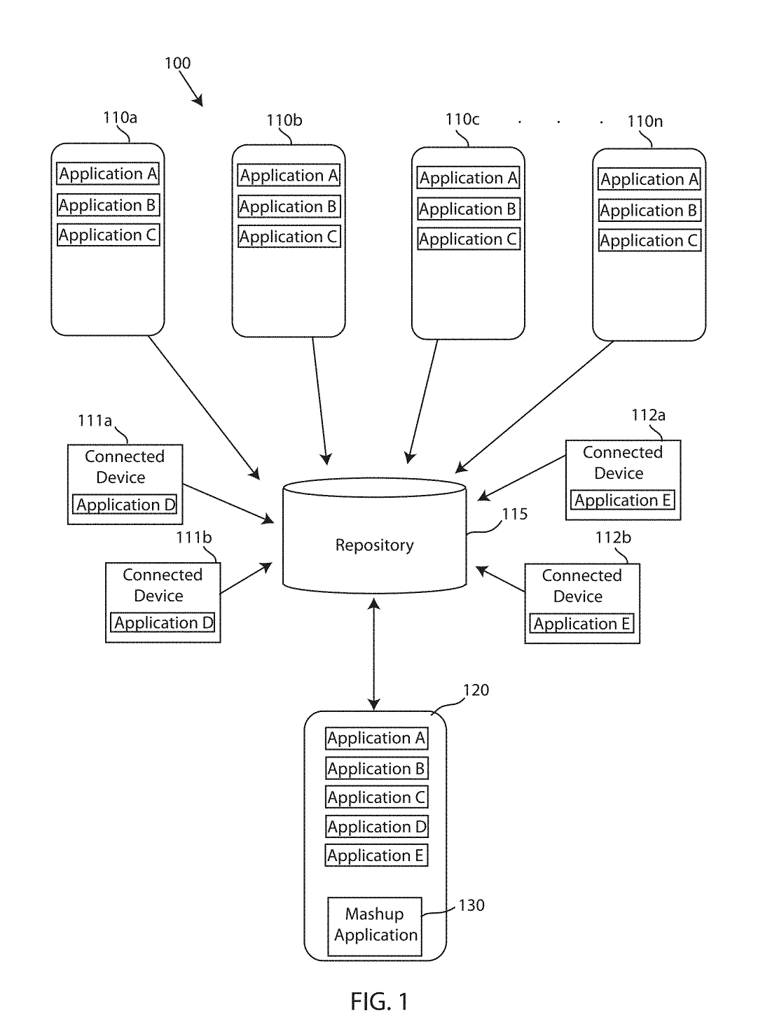

Referring now to the drawings, FIG. 1 depicts a block diagram of a mashup system 100, in accordance with embodiments of the present invention. Embodiments of a mashup system 100 may run on a user computing device, such as a mobile phone, and may mashup several applications deployed on the user computer device as well as applications deployed on other computing devices having a relationship to the user computer device. For instance, the user computer device, depicted as computing system 120, may have a relationship with the users of devices 100a, 110b, 110c . . . 10n. In one embodiment, the relationship may be that the devices 110a, 110b, 110c . . . 110n may belong to family members and/or friends of the user. In another embodiment, the relationship may be that the devices 110a, 110b, 110c . . . 110n may belong to employees or coworkers of the user. In further embodiments, the devices 110a, 110b, 110c . . . 110n may be multiple devices owned and/or operated by the user, other than the computing system 120. Further, embodiments of the devices 110a, 110b, 110c . . . 110n may be a combination of the user's additional device(s), family/friend devices, employees, coworkers, and the like.

Embodiments of the devices 110a, 110b, 110c . . . 110n may be a mobile device, a mobile computing device, a smartphone, a tablet, a cellular phone, desktop computer, laptop computer, or other computing device capable of installing and running a software application. Each of the mobile devices 110a, 110b, 110c . . . 110n may include one or more deployed applications. In FIG. 1, deployed applications loaded on devices 110a, 110b, 110c . . . 110n are depicted as Application A, Application B, and Application C. Devices 110a, 110b, 110c . . . 110n may include more than the depicted applications, and may not include one or more of the depicted applications. In an exemplary embodiment, Application A may be a banking application that may keep track of finances associated with one or more bank accounts, credit card accounts, etc., Application B may be a bill payment application that may allow a user to pay various invoices, bills, etc., and Application C may be a to-do list application that may be used to track tasks and to-do items to help the user stay organized. Embodiments of Application A, Application B, and Application C may however be any software application capable of being downloaded onto devices 110a, 110b, 110c . . . 110n, and computing system 120, including but not limited to banking application, social media application, to-do application, email application, game application, home monitoring application, web browser application, messaging application, media content streaming application, shopping application, fitness application, word processing application, music player application, and any software application downloadable from an application store.

Moreover, Application A deployed on device 110a may be the exact same application deployed on the other devices 110b, 110c . . . 110n and computing system 120. Likewise, Application B and Application C deployed on device 110a may be the exact same application deployed on the other devices 110b, 110c . . . 110n, and computing system 120. However, each device having Application A, Application B, and Application C may have a distinct user account associated therewith. For instance, a user associated with device 110a may have a user account associated with Application A, wherein application data for Application A is stored on the device 110a or stored remotely but associated with that user account or device 110a. The application data associated with Application A, Application B, and Application C may be transmitted, sent, or otherwise provided to a central repository 115 from each device 110a, 110b, 110c . . . 110n, and stored using industry standard format, such as JSON.

Embodiments of mashup system 100 may further include connected devices 111a, 111b, 112a, 112b. Embodiments of connected devices 111a, 111b, 112a, 112b may be a smart device, a physical device or system capable of connecting to the Internet, a computing device, a smart object, a connected device, a sensor, or other device having network connectivity and at least one processor. Examples of a connected device 111a, 111b, 112a, 112b may be a thermostat, an energy management system, a refrigerator or other smart appliance, a smart voice enabled wireless speaker, a television, a media streaming device, HVAC sensors, automobiles, and the like. Further examples of connected devices 111a, 111a, 112a, 112b may be a component in the Internet of Thing (IoT). The connected devices 111a, 111a, 112a, 112b may be capable of installing and/or running a preloaded or later downloaded software application. Each of the connected devices 111a, 111a, 112a, 112b may include one or more deployed applications. In FIG. 1, deployed applications loaded on connected devices 111a, 111a, 112a, 112b are depicted as Application D and Application E. Connected devices 111a, 111a, 112a, 112b may include more than the depicted applications, and may not include one or more of the depicted applications. In an exemplary embodiment, Application D may be a learning thermostat application that may allow a user to remotely change a temperature of an environment in which the learning thermostat is located, and Application E may be software application associated with a smart refrigerator that is configured to track inventory levels inside of a refrigerator. Embodiments of Application D and Application E may however be any software application capable of running connected devices 111a, 111a, 112a, 112b, and computing system 120,

Moreover, Application D deployed on connected device 111a may be the exact same application deployed on another connected device 111b (e.g. two learning thermostats in a household environment) and computing system 120. Likewise, Application D deployed on device 112a may be the exact same application deployed on another devices 112b (e.g. two commercial refrigerators at a grocery store), and computing system 120. However, each device having Application D and Application E may have a distinct user or device account associated therewith (e.g. serial number of device). For instance, a device account associated with device 111a may have a device account associated with Application D, wherein application data for Application D is stored on the device 111a or stored remotely but associated with that device account or device 111a. The application data associated with Application D and Application E may be transmitted, sent, or otherwise provided to a central repository 115 from each connected devices 111a, 111a, 112a, 112b, and stored using industry standard format, such as JSON.

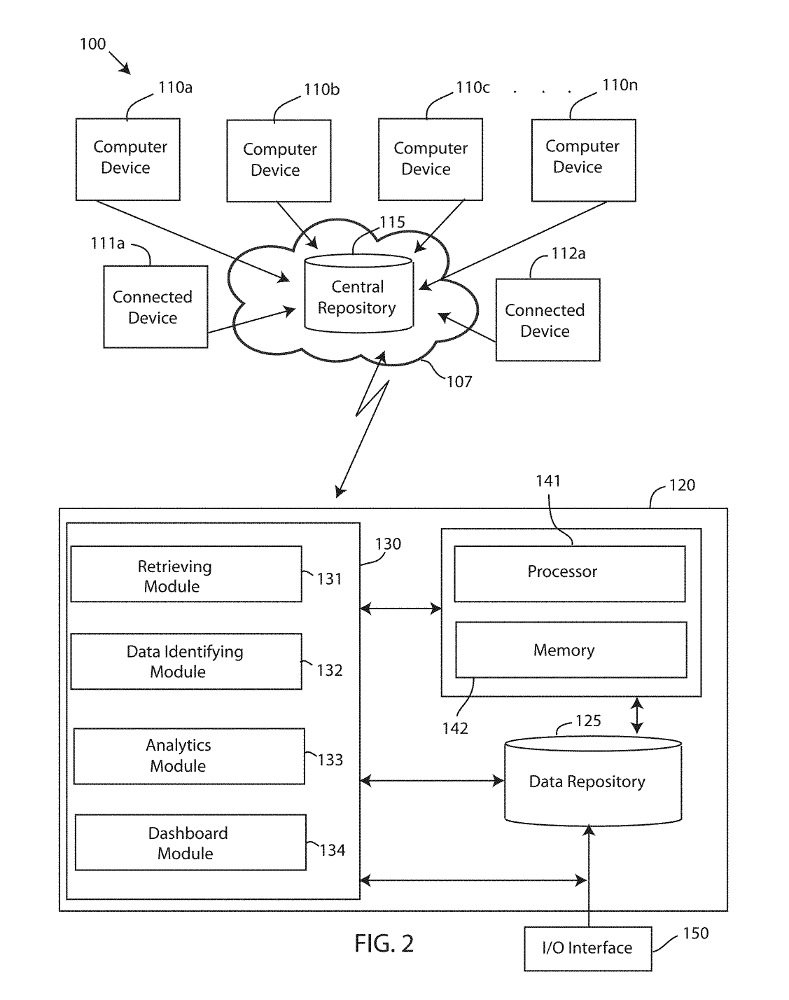

Embodiments of mashup system 100 may include a computing system 120. Embodiments of computing system 120 may include Applications A-E, and may also include a mashup application 130. FIG. 2 depicts a block diagram of mashup system 100 and computing system 120, in accordance with embodiments of the present invention. Embodiment of mashup system 100 may comprise a central repository 115. Embodiments of the central repository may be a cloud storage device(s), configured to receive application data from the devices 110a, 110b, 110c . . . 110n and connected devices 111a, 111b, 112a, 112b. Embodiments of the repository 115 may be located in the network 107, such as a cloud computing network. Embodiments of the repository 115 may accessible by the computing system 120 over network 107. A network 107 may be the cloud. Further embodiments of network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computer system 120, a connection to one or more network accessible knowledge bases containing information of the user, network repositories or other systems connected to the network 107 that may be considered nodes of the network 107. In some embodiments, where the computing system 120 or network repositories allocate resources to be used by the other nodes of the network 107, the computer system 120 and network repository may be referred to as servers.

The network repository may be a data collection area on the network 107 which may back up and save all the data transmitted back and forth between the nodes of the network 107. For example, the network repository may be a data center saving and cataloging user preferences or permissions allowed, granted, and/or simulated to generate both historical and predictive reports regarding a particular user. In some embodiments, a data collection center housing the network repository may include an analytic module capable of analyzing each piece of data being stored by the network repository. Further, the computer system 120 may be integrated with or as a part of the data collection center housing the network repository. In some alternative embodiments, the network repository may be a local repository that is connected to the computer system 120.

Further, embodiments of the computing system 120 may include an I/O interface 150, which may enable any communication process performed between the computer system 120 and the environment outside of the computer system 120. Input to the computing system 120 may enable the signals or instructions sent to the computing system 120, for example information provided by the user to the computing system 120, while output may enable the signals sent out from the computer system 120. Embodiments of the I/O interface 150 may also be connected to the computing system 120 over a network, such as network 107.

Referring still to FIG. 1, embodiments of the computing system 120 may receive user data requested by the mashup application 130 via I/O interfaces 150. Input devices or input mechanisms associated with the I/O interfaces 150 may be a touchscreen of a mobile device. Other inputs may be used to collect user data or preferences, such as one or more connected microphones positioned nearby the user or a built-in microphone of the user's mobile device to allow voice-commands, a keyboard, a webcam, mouse, touchpad, stylus, and the like, or other peripheral devices connected to the computing system 120 over the network 107 or via Bluetooth, IR, or other short range communication networks.

Embodiments of the computer system 120 may be equipped with a memory device 142 which may store the user selections, and a processor 141 for implementing the tasks associated with the mashup system 100. In some embodiments, Applications A-E may be loaded in the memory 142 of the computer system 120. Further, in some embodiments, mashup application 130 may be loaded into the memory 142 of the computing system 120. The computing system 120 may further include an operating system, which can be a computer program for controlling an operation of the computing system 120, wherein applications loaded onto the computing device 120 may run on top of the operating system to provide various functions.

Furthermore, embodiments of computer system 120 may include a mashup application 130. Embodiments of the mashup application 120 may be an interface, an application, a program, or a combination of modules. In an exemplary embodiment, the mashup application 130 may include a retrieving module 131, a data identifying module 132, an analytics module 133, and a dashboard module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the retrieval module 131 may include one or more components of hardware and/or software program code for retrieving application data of the plurality of deployed applications (e.g. Applications A-E) generated by the plurality of devices 110a, 110b, 110c . . . 110n, 111a, 111b, 112a, 112b. For example, the retrieval module 131 may retrieve or otherwise obtain the application data from cloud storage. The retrieval module 131 may retrieve the application data from the cloud storage device 115 in response to the application being sent to the storage device 115, so that the computing system 120 include the most recent data. For instance, a notification or request to retrieve data may be sent from the devices 110a, 110b, 110c . . . 110n, 111a, 111b, 112a, 112b to the computing system 120 when application data is transmitted to the repository 115. In other embodiments, the retrieval module 131 may retrieve or pull data from the cloud automatically when application data is transmitted to the cloud storage device 115. In further embodiments, the retrieval module 131 may pull data from the cloud storage device 115 periodically (e.g. seconds, minutes, hours, days, etc.).

With continued reference to FIG. 2, embodiments of the computing system 120 may further include a data identifying module 132. Embodiments of the data identifying module 132 may include one or more components of hardware and/or software program code for identifying and/or categorizing the application data retrieved from the central repository 115. For example, embodiments of the data identifying module 132 may identify an application data associated with a first deployed application, such Application A, using a pre-defined data mining template corresponding to the first deployed application, Application A. The data identifying module 132 may likewise identify an application data associated with a second deployed application, such as Application B, using a pre-defined data mining template corresponding to the second deployed application, Application B. Embodiments of the data mining template may be tailored or customized to be used with the deployed applications, such that the data mining template can be used to extract content and identify characteristics of the application data accordingly.

The data identifying module 132 may identify the application data for a particular application so that the application data is stored in the proper place, along with other application data from the same application generated by other devices in the system 100. Furthermore, the data identifying module 132 may also identify the particular device that generated the application data for a particular deployed application. This identification of the user/device by the data identifying module 132 may help the computing system 120 generate detailed and more accurate contextual insights and analysis that may be specific to a particular user or device.

Referring still to FIG. 2, embodiments of the computing system 120 may further include an analytics module 133. Embodiments of the analytics module 133 may include one or more components of hardware and/or software program code for analyzing the application data associated with the first deployed application and the application data associated with the second deployed application along with a user specific information to provide one or more contextual insights or notifications to the user on a single display associated with the computing system 120. For example, the analytics module 133 may analyze the application data and the user specific information to provide a mashup view of information and data relating to multiple applications from multiple devices 110a, 110b, 110c . . . 110n, 111a, 111b, 112a, 112b. In addition to analyzing the application data to prepare a mashup of the various applications and application data associated therewith, the analytics module 133 may also analyze a user specific information to provide contextual insights that are relevant to a particular application. Embodiments of user specific information may include at least one of a geographical location of the user, a user history of the first deployed application and the second deployed location, a preference of the user, a relationship to the plurality of connected devices, a privacy setting of the user, a home location of the user, an work environment of the user, an office location of the user, a schedule of the user, and a combination thereof.

Accordingly, embodiments of the analytics module 133, by analyzing the application data and the user specific information, may provide the user with contextual insights into the data from applications deployed on multiple devices, which are presented to the user on the computing system 120. For example, the user may be provided with a consolidated list of all the bill payments pending for the user and the user's family members/coworkers, friends, employees, etc., wherein the mashup application can notify the user about bill payments, for example on preferred date as predetermined by the user. In another example, the analytics module 133 informs the user now about exact expenses made by the user and the user's family members, by picking up the details of the expenses from the expenses application (e.g. Application A) installed in the user's spouse and/or dependent parent's devices. The mashup application 130 may also provide contextual information/notification as to whether the user needs to withdraw some cash for the user's family members, and may be notified while the user is located close to an ATM, based on location information of the user, or while the user is driving home from an office location. In another example, the analytics module 133 may analyze the application data and the user specific information so that the user now also gets to know about the details of any emergency to-do's list, such as picking up a prescription medication for the user's elderly father, which the analytics module 133 determined was needed based on application data from a healthcare application deployed on the father's mobile device. Similarly, the analytics module 133 may determine that the user needs groceries based on application data provided from the smart refrigerator, as well as suggest a closest grocery store based on the user's current location. The contextual insights into the received application data is provided to the user operating the mashup application 130 on computing system 120, and encompasses information/data from several different applications that are typically only located on each separate device.

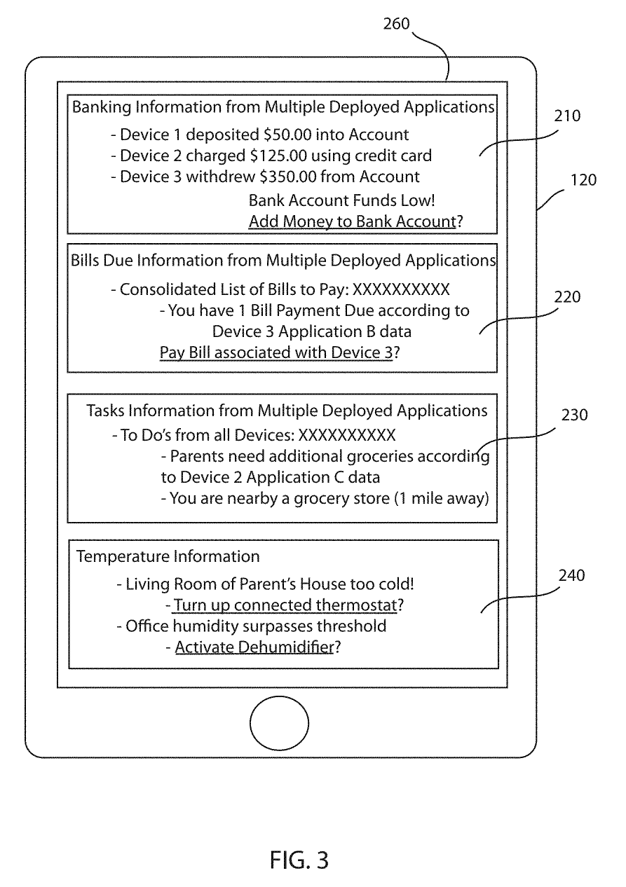

With continued reference to FIG. 2, embodiments of the computing system 120 may also include a dashboard module 134. Embodiments of the dashboard module 134 may include one or more components of hardware and/or software program code for presenting the application data from the deployed application deployed on multiple different devices on a single display of the computing system 120. FIG. 3 depicts an embodiment of a dashboard of a user device displaying application data from several deployed application across several devices and various contextual insights, in accordance with embodiments of the present invention. For instance, one or more contextual insights or notifications may be presented to the user as a dashboard 260 of a display of the computing system 120. Embodiments of the dashboard 260 may include a first interface portion 210 dedicated to the application data associated with the first deployed application and a second interface portion 220 dedicated to the application data associated with the second deployed application, so that a user views the application data, from the first deployed application and the second deployed application generated by the plurality of connected devices, on the single display associated with the computing system 120. Embodiments of the dashboard may include a third interface portion 230 dedicated to the application data associated with a third deployed application, and a fourth interface portion 240 dedicated to the application data associated with a fourth deployed application data. Embodiments of the dashboard 260 may include a plurality of interface portions corresponding to a number of deployed applications being mashed up by the mashup application 130. Moreover, embodiments of the interface portions 210, 220, 230, 240 may be windows or views for displaying content and/or information relating to a specific application. In some embodiments, the dashboard module 134 may group similar application together for displaying on the dashboard 134 by a category. For instance, embodiments of the dashboard module 134 may group application data analyzed by the analytics module 133 that pertain to “banking,” but involves application data from one or more applications, such a bank account application, credit card application, online money transfer applications, bitcoin applications, and the like. The dashboard module 134 may utilize the plurality of data streams from several different deployed applications relating to “banking” from several mobile devices.

Referring to FIG. 3, an embodiment of a dashboard 260 being displayed on a user device, such as computing system 120, includes a first interface portion 210 dedicated to banking information received from multiple deployed applications. The first interface portion 210 provides information to the user of the banking activity of the various other users or devices, which are using applications installed on those devices. Based on the banking activity, the user is provided a contextual insight that “bank account funds are low!” The user is now aware the user must take an action to prevent an overdraft pf the bank account. Even further, the dashboard module 134 may provide a link for the user to take action. For example, the first interface portion 210 of the dashboard 260 may include a link to “Add Money to Bank Account?” The user may follow the link to add funds to the bank account that is low on funds. Furthermore, embodiments of the second interface portion 220 may be dedicated to bill payment information received from multiple deployed applications. The second interface portion 220 provided information to the user of the bills that are due, which is presented in a consolidated list of bills to pay. Based on the bill payment information from one of the devices other than the user's device, the user is provided a contextual insight that a bill is due. The dashboard module 134 may provide a link for the user to take action. For example, the second interface portion 220 of the dashboard 260 may include a link to “Pay Bill Associated with Device 3?” The user may follow the link to facilitate payment of the bill.

A third interface portion 230 is dedicated to task lists received from multiple deployed applications. The third interface portion 230 provides information to the user of the task lists for the user and for the various other users or devices, which are using applications installed on those devices. Based on the consolidated and updated task list from the user's parents' device that is now displayed in one application 130 on the user's device, the user is provided a contextual insight that “Parents Need Additional Groceries.” The user is now aware that the user's parents need groceries. Additionally, based on user specific information that the user is close to a grocery store, the user is provided a contextual insight that “You Are Nearby a Grocery Store (1 mile away).” The dashboard module 134 may provide a link for the user to take action. For example, the third interface portion 230 of the dashboard 260 may include a link to a directions application for precise directions to the grocery store. Embodiments of the dashboard 260 may also include a fourth interface portion 240 dedicated to temperature data of the user's house, the user's office, and the user's parents' house. The fourth interface portion 240 provides temperature data from various locations in the user's house from multiple smart thermostats. Based on the application data received from multiple smart thermostats displayed by a single application 130 on the user's device, the user is provided with a contextual insight that “The Living Room of Parent's House is Too Cold!” The user is now aware that the user's parents' living room is too cold. The dashboard module 134 may provide a link for the user to take action. For example, the fourth interface portion 240 of the dashboard 260 may include a link to control the smart thermostat located in the user's parents' home. In addition, the user is provided with a contextual insight that “Office Humidity Has Surpassed Threshold.” The user is now aware that the office humidity has surpassed a threshold, which normally would have only been reported to the user's work device. The dashboard module 134 may generate a link to activate a dehumidifier to lower the humidity level.

Embodiments of the mashup application 130 further allows for building custom dashboards. For instance, the user can design the user's dashboards to take action from the mashup application 130, show the overview of bill reminders, link to bank account that helps to pay off the bills with a click of a button, and the like. The user's customized dashboard may also include an interface portion dedicated to device specific data, such as battery percentage, GPS location of each device, connectivity levels, etc. of the user's device and the other devices.

Accordingly, embodiments of the mashup system 100 may provide contextual insights from deployed applications in multiple devices by correlating the information and data from distinct applications installed in various devices and applying contextual intelligence to provide meaningful insights based on user specific information, such as location and user preferences. Although embodiments of the mashup system 100 has been described largely in a mobile application scenario, the mashup system 100 is not limited to mobile application scenarios, but can be easily extended to enterprise grade cloud applications and to IoT based devices to create contextual insights from distinct IoT devices/cloud applications as well. IoT devices may relate to smart entertainment, real-time alerts, smart lighting, temperature control, security & surveillance, safety, elderly care, health & wellness, and energy management. Embodiments of the mashup system 100 as it relates to IoT devices, such as connected device 111a, 111b, 112a, 112b, may integrate all the data generated from these IoT devices as part of the user data for deriving contextual insights. Further, embodiments of the mashup system 100 may be adopted for enterprise grade application running on the cloud. Each enterprise applications of an organization can be hosted on various cloud infrastructures. If all the enterprise applications are related to a single organization, the enterprise could use a system that can provide contextual insights to monitor and manage distinct applications running on multiple cloud infrastructures.

Further, embodiments of the mashup system 100 may provide a contextual insight into all the data that matters and related to a user in a single pane of glass (e.g. dashboard graphic user interface on screen of mobile device). Data related to the user may take every possible aspect of the user's life into consideration, such as work related data, personal data, home data (e.g. generated by IoT devices at home), spouse and kid's data, parent's data and data from other relationships that affects the user's life in a day-to-day manner.

Moreover, embodiments of the mashup system 100 may be a client side application solution as opposed to a traditional server side application for solving such a problem statement. The system 100 being a client side application may: a) allow users to view the dashboard in an offline mode, which is refreshed once connected and/or when new data is received and available for display, b) allow the mashup application 130 to exploit the mobile operating system capabilities and features that allows the user to even include device related data, such as battery and memory usage statistics into their custom dashboard; and c) give a complete flexibility for users to customize the user's dashboards view.

Accordingly, embodiments of system 100 including computing system 120 having mashup application 130 may be referred to as a system and method of building a client side mashup application with the capabilities of retrieving data from a central cloud repository based on user's preferences, a system and method of allowing users to view the data stored from multiple applications deployed in multiple devices without a need for duplicating the data, a system, method and architecture of the mashup application 130 that is built with the intelligence of user history, location details and other preferences to provide contextual insights and/or notifications to the user, and a system, method and architecture of pre-defined data mining templates for popular and common applications, that are capable of retrieving data from similar applications and displaying the data in an intuitive manner that distinguishes data from different devices.

Various tasks and specific functions of the modules of the computing system 120 may be performed by additional modules, or may be combined into other module(s) to reduce the number of modules. Further, embodiments of the computer or computer system 120 may comprise specialized, non-generic hardware and circuitry (i.e., specialized discrete non-generic analog, digital, and logic based circuitry) for (independently or in combination) particularized for executing only methods of the present invention. The specialized discrete non-generic analog, digital, and logic based circuitry may include proprietary specially designed components (e.g., a specialized integrated circuit, such as for example an Application Specific Integrated Circuit (ASIC), designed for only implementing methods of the present invention). Moreover, embodiments of the mashup system 100 may improve computer technology, whereby utilizing a processing power of a single device to correlate application data from several applications deployed on several different devices to provide contextual insights to the user on the single device, which would have previously required consulting several different mobile devices.

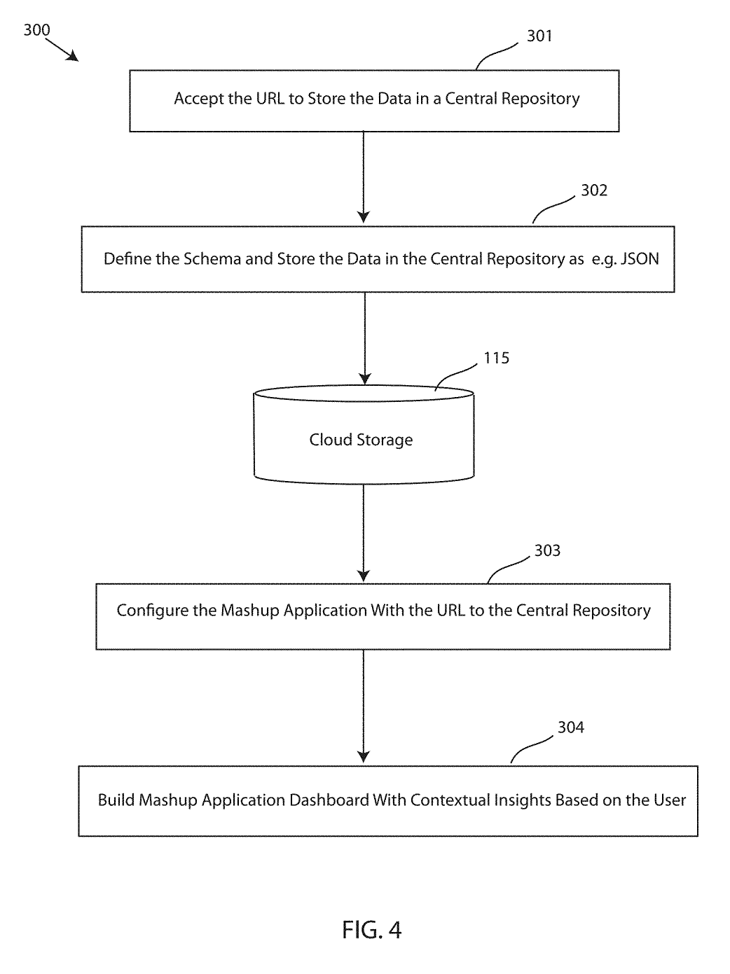

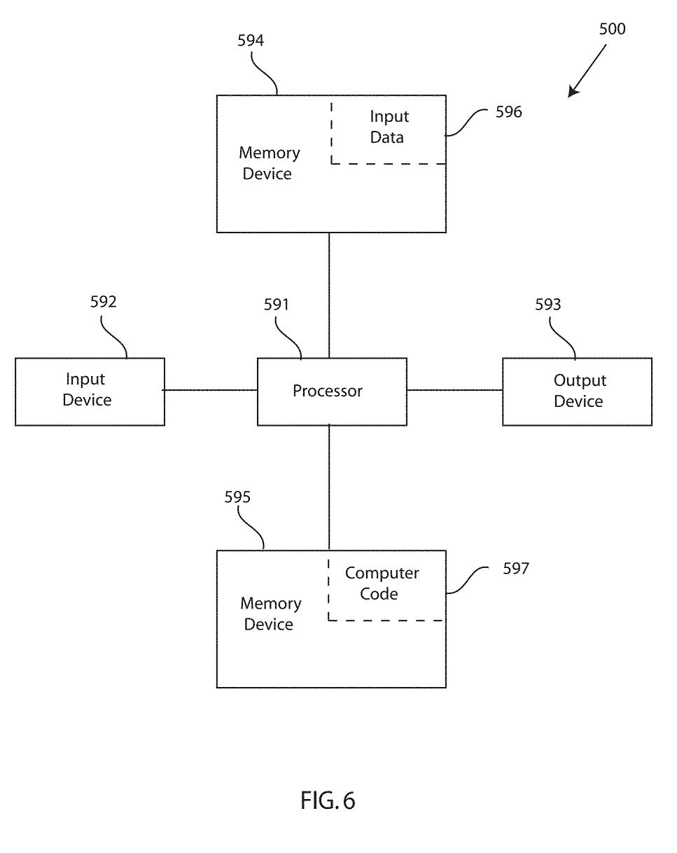

Referring now to FIG. 4, which depicts a flow chart of a first method 300 for providing contextual insights and notifications regarding a plurality of deployed applications deployed across a plurality of devices, in accordance with embodiments of the present invention. One embodiment of a method 300 or algorithm that may be implemented providing contextual insights and notifications regarding a plurality of deployed applications deployed across a plurality of devices in accordance with the mashup system 100 described in FIGS. 1-3 using one or more computer systems as defined generically in FIG. 6 below, and more specifically by the specific embodiments of FIGS. 1-2.

Embodiments of the method 300 providing contextual insights and notifications regarding a plurality of deployed applications deployed across a plurality of devices, in accordance with embodiments of the present invention may begin at step 301 wherein a URL is accepted to store the data in the central repository 115. Step 302 defines the schema and stores the application data in the central repository 115, in an industry standard format, such as JSON. Step 303 configures the mashup application 130 with the URL to the central repository 115. Strep 304 builds the mashup application dashboard 260 with contextual insights, using user specific information.

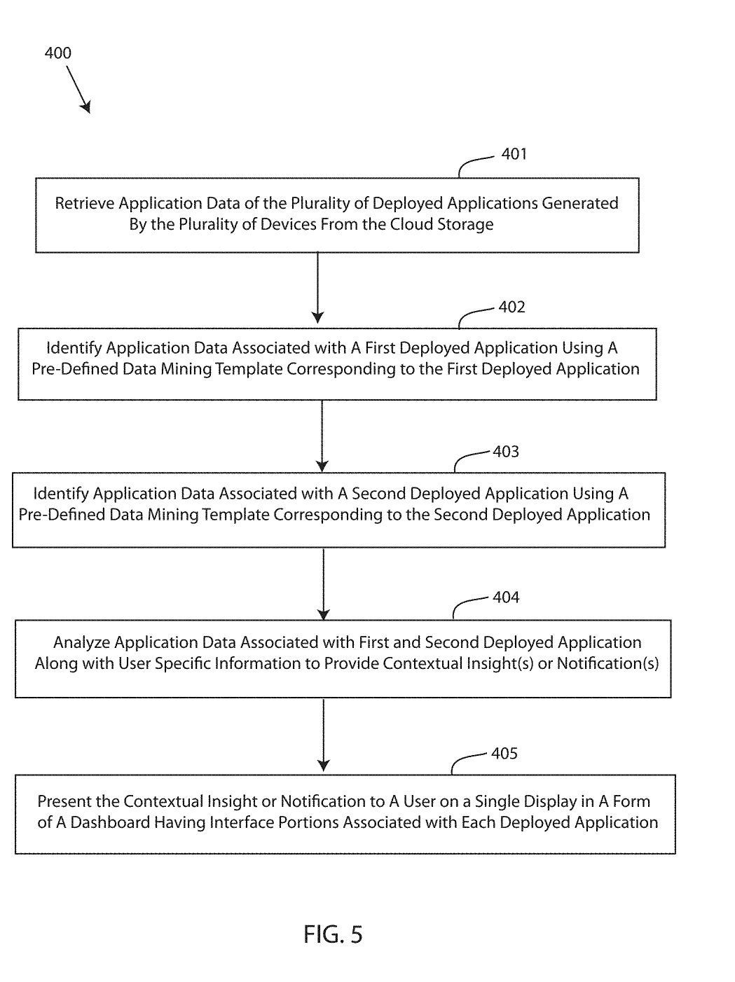

FIG. 5 depicts a flow chart of a second method 400 for providing contextual insights and notifications regarding a plurality of deployed applications deployed across a plurality of devices, in accordance with embodiments of the present invention. One embodiment of a method 400 or algorithm that may be implemented providing contextual insights and notifications regarding a plurality of deployed applications deployed across a plurality of devices in accordance with the mashup system 100 described in FIGS. 1-3 using one or more computer systems as defined generically in FIG. 6 below, and more specifically by the specific embodiments of FIGS. 1-2.

Embodiments of the method 400 for providing contextual insights and notifications regarding a plurality of deployed applications deployed across a plurality of devices, in accordance with embodiments of the present invention may begin at step 401, wherein application data of the plurality of deployed applications generated by the plurality of devices 110a, 110b, 110c . . . 110n, 111a, 111b, 112a, 112b is retrieved from the cloud storage database 115. Step 402 identifies application data associated with a first deployed application using a predefined data mining template corresponding to the first deployed application. Similarly, step 403 identifies application data associated with a second deployed application using a predefined data mining template corresponding to the second deployed application. Step 404 analyzes the application data associated with the first deployed application and the second deployed application along with user specific information to provide contextual insights and/or notifications. Step 405 presents the contextual insights and/or notifications to a user on a single display in a form of a dashboard 260 having interface portion 210, 220, 230, 240 associated with each deployed applications or a group of related applications.

FIG. 6 illustrates a block diagram of a computer system for the mashup system of FIGS. 1-3, capable of implementing methods for providing contextual insights and notifications regarding a plurality of deployed applications deployed across a plurality of devices of FIGS. 4-5, in accordance with embodiments of the present disclosure. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for providing contextual insights and notifications regarding a plurality of deployed applications deployed across a plurality of devices, in the manner prescribed by the embodiments of FIGS. 4-5 using the mashup system 100 of FIGS. 1-2, wherein the instructions of the computer code 597 may be executed by processor 591 via memory device 595. The computer code 597 may include software or program instructions that may implement one or more algorithms for implementing the methods for providing contextual insights and notifications regarding a plurality of deployed applications deployed across a plurality of devices, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a mobile device. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 2.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to mashup systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to manage application permissions. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method of processing application permissions. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for providing contextual insights and notifications regarding a plurality of deployed applications deployed across a plurality of devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

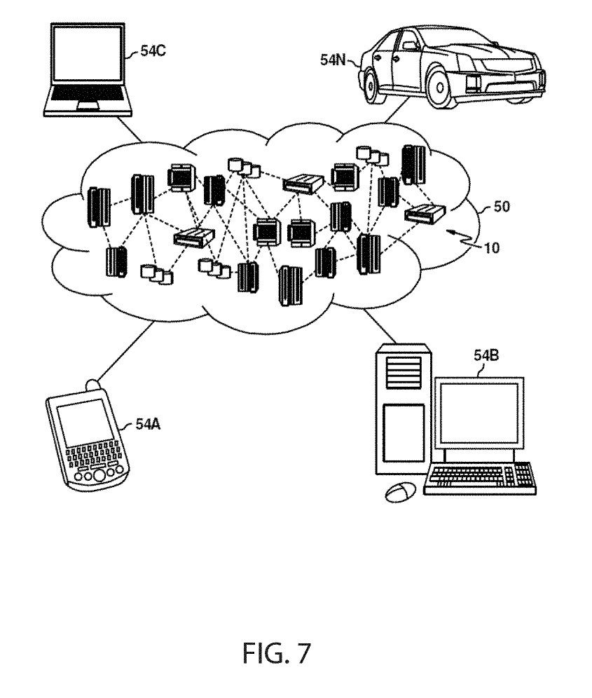

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 7 are intended to be illustrative only and that computing nodes 10 and cloud computing environment 50 can communicate with any type of computerized device over any type of network and/or network addressable connection (e.g., using a web browser).

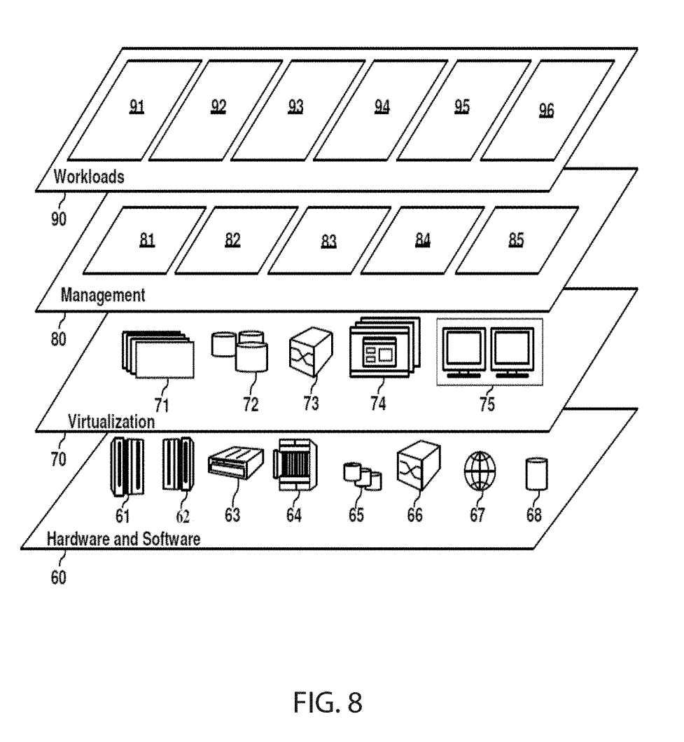

Referring now to FIG. 8, a set of functional abstraction layers provided by cloud computing environment 50 (see FIG. 7) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and contextual insight for mashup application generation and processing 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method for providing contextual insights and notifications regarding a plurality of deployed applications deployed across a plurality of devices, the method comprising:
retrieving, by a processor of a computing system, application data of the plurality of deployed applications generated by the plurality of devices, which is stored on a central cloud storage repository, wherein the plurality of devices each include a first deployed application and a second deployed application;
identifying, by the processor, an application data associated with the first deployed application using a pre-defined data mining template corresponding to the first deployed application, and an application data associated with the second deployed application using a pre-defined data mining template corresponding to the second deployed application; and
analyzing, by the processor, the application data associated with the first deployed application and the application data associated with the second deployed application along with a user specific information to provide one or more contextual insights or notifications to the user on a single display associated with the computing system.

2. The method of claim 1, wherein the application data is stored on the central cloud repository in an industry standard format.

3. The method of claim 1, wherein the one or more contextual insights or notifications are presented to the user on a dashboard having a first interface portion dedicated to the application data associated with the first deployed application and a second interface portion dedicated to the application data associated with the second deployed application, so that a user views the application data, from the first deployed application and the second deployed application generated by the plurality of connected devices, on the single display associated with the computing system.

4. The method of claim 1, wherein the user specific information is selected from the group consisting of: a geographical location of the user, a user history of the first deployed application and the second deployed location, a preference of the user, a relationship to the plurality of connected devices, a privacy setting of the user, a home location of the user, a work environment of the user, an office location of the user, a schedule of the user, and a combination thereof.

5. The method of claim 3, wherein the one or more contextual insights or notifications vary depending a selected user specific information, and the dashboard is customizable based on an application preference.

6. The method of claim 1, further comprising:
additionally identifying, by the processor, an application data associated with a third deployed application using a pre-defined data mining template corresponding to the third deployed application, and an application data associated with a fourth deployed application using a pre-defined data mining template corresponding to the fourth deployed application;
wherein the third deployed application and the fourth deployed application are deployed on a smart device.

7. The method of claim 6, wherein a device of the plurality of device is a computing device capable of network connectivity, and the smart device is a physical device capable of network connectivity.

8. A computer system, comprising:
a processor;
a memory device coupled to the processor; and
a computer readable storage device coupled to the processor, wherein the storage device contains program code executable by the processor via the memory device to implement a method for providing contextual insights and notifications regarding a plurality of deployed applications deployed across a plurality of devices, the method comprising:
retrieving, by a processor of a computing system, application data of the plurality of deployed applications generated by the plurality of devices, which is stored on a central cloud storage repository, wherein the plurality of devices each include a first deployed application and a second deployed application;
identifying, by the processor, an application data associated with the first deployed application using a pre-defined data mining template corresponding to the first deployed application, and an application data associated with the second deployed application using a pre-defined data mining template corresponding to the second deployed application; and
analyzing, by the processor, the application data associated with the first deployed application and the application data associated with the second deployed application along with a user specific information to provide one or more contextual insights or notifications to the user on a single display associated with the computing system.

9. The computer system of claim 8, wherein the application data is stored on the central cloud repository in an industry standard format.

10. The computer system of claim 8, wherein the one or more contextual insights or notifications are presented to the user on a dashboard having a first interface portion dedicated to the application data associated with the first deployed application and a second interface portion dedicated to the application data associated with the second deployed application, so that a user views the application data, from the first deployed application and the second deployed application generated by the plurality of connected devices, on the single display associated with the computing system.

11. The computer system of claim 8, wherein the user specific information is selected from the group consisting of: a geographical location of the user, a user history of the first deployed application and the second deployed location, a preference of the user, a relationship to the plurality of connected devices, a privacy setting of the user, a home location of the user, a work environment of the user, an office location of the user, a schedule of the user, and a combination thereof.

12. The computer system of claim 10, wherein the one or more contextual insights or notifications vary depending a selected user specific information, and the dashboard is customizable based on an application preference.

13. The computer system of claim 8, further comprising:
additionally identifying, by the processor, an application data associated with a third deployed application using a pre-defined data mining template corresponding to the third deployed application, and an application data associated with a fourth deployed application using a pre-defined data mining template corresponding to the fourth deployed application;
wherein the third deployed application and the fourth deployed application are deployed on a smart device.

14. The computer system of claim 13, wherein a device of the plurality of device is a computing device capable of network connectivity, and the smart device is a physical device capable of network connectivity.

15. A computer program product, comprising a computer readable hardware storage device storing a computer readable program code, the computer readable program code comprising an algorithm that when executed by a computer processor of a computing system implements a method for providing contextual insights and notifications regarding a plurality of deployed applications deployed across a plurality of devices, comprising:
retrieving, by a processor of a computing system, application data of the plurality of deployed applications generated by the plurality of devices, which is stored on a central cloud storage repository, wherein the plurality of devices each include a first deployed application and a second deployed application;
identifying, by the processor, an application data associated with the first deployed application using a pre-defined data mining template corresponding to the first deployed application, and an application data associated with the second deployed application using a pre-defined data mining template corresponding to the second deployed application; and
analyzing, by the processor, the application data associated with the first deployed application and the application data associated with the second deployed application along with a user specific information to provide one or more contextual insights or notifications to the user on a single display associated with the computing system.

16. The computer program product of claim 15, wherein the application data is stored on the central cloud repository in an industry standard format.

17. The computer program product of claim 15, wherein the one or more contextual insights or notifications are presented to the user on a dashboard having a first interface portion dedicated to the application data associated with the first deployed application and a second interface portion dedicated to the application data associated with the second deployed application, so that a user views the application data, from the first deployed application and the second deployed application generated by the plurality of connected devices, on the single display associated with the computing system.

18. The computer program product of claim 15, wherein the user specific information is selected from the group consisting of: a geographical location of the user, a user history of the first deployed application and the second deployed location, a preference of the user, a relationship to the plurality of connected devices, a privacy setting of the user, a home location of the user, a work environment of the user, an office location of the user, a schedule of the user, and a combination thereof.

19. The computer program product of claim 15, further comprising:
additionally identifying, by the processor, an application data associated with a third deployed application using a pre-defined data mining template corresponding to the third deployed application, and an application data associated with a fourth deployed application using a pre-defined data mining template corresponding to the fourth deployed application;
wherein the third deployed application and the fourth deployed application are deployed on a smart device.

20. The computer program product of claim 19, wherein a device of the plurality of device is a computing device capable of network connectivity, and the smart device is a physical device capable of network connectivity.
